(19) United States
(12) Patent Application Publication
(10) Pub. No.: US 2014/0279445 A1
(43) Pub. Date: Sep. 18, 2014

(54) Method, Apparatus, and System for Processing Transactions

(71) Applicant: Tencent Technology (Shenzhen) Company Limited, Shenzhen (CN)

(72) Inventors: Nan JIANG, Shenzhen (CN); Hongbo SHI, Shenzhen (CN); Jun SHI, Shenzhen (CN); Peng LIU, Shenzhen (CN); Maocai LI, Shenzhen (CN); Chen GONG, Shenzhen (CN)

(73) Assignee: Tencent Technology (Shenzhen) Company Limited, Shenzhen (CN)

(21) Appl. No.: 14/258,940

(22) Filed: Apr. 22, 2014

Related U.S. Application Data
(63) Continuation of application No. PCT/CN2013/090974, filed on Dec. 30, 2013.

(30) Foreign Application Priority Data
Mar. 18, 2013 (CN) 201310086449.X

(51) Int. Cl. G06Q 20/10

(52) U.S. Cl. CPC G06Q 20/10
USPC 705/39

(57) ABSTRACT

A method, apparatus, and system are disclosed for processing transactions in the field of Internet communication. In the method: a first terminal scans a graphic code of a transaction, acquires a process ID of the transaction from the graphic code, where the graphic code is generated by a payment system from its acquired transaction information of the transaction, the transaction information including at least ID of a first party and a transaction value of the transaction. The first terminal transmits a user account of a second party and the process ID to the payment system. The payment system acquires the transaction information of the transaction, reduces the transaction value from a first value included in the user account of the second party and adds the transaction value to a second value included in the user account of the first party.

### CROSS-REFERENCE TO RELATED APPLICATIONS

This application is a continuation of International Application No. PCT/CN2013/090974, filed on Dec. 30, 2013, which claims priority to Chinese Patent Application No. 201310086449.X, filed on Mar. 18, 2013, which is hereby incorporated herein by reference in their entireties.

### FIELD

The present disclosure relates generally to the field of Internet communication and, more particularly, to a method, apparatus and system for processing transactions.

### BACKGROUND

In everyday life, people often need to purchase merchandises and fully pay the amounts due. For example, people often make their picks and proceed to the cashier counter to make payment; the cashier inputs the merchandises to the cashing machine and the cashing machine sums up the amount payable; and the amount may then be paid by cash or using payment card.

If cash is used for the processing, then people often have to carry cash and return of change is often occurs. When the monetary amount for a purchase is large, carrying a lot of cash results in low processing convenience. If card is used, the merchant needs to provide special equipment to support card payment, e.g. for bank debit card the merchant need to provide a point-of-sale (POS) machine, and this increases operating cost of the merchant.

### SUMMARY

To improve processing convenience and reduce operating cost, the present disclosure provides a method, apparatus and system for processing transactions. The solutions of the present disclosure are as follows:

In an aspect, a method for processing transactions includes the following: a device scans a graphic code of a transaction, acquires a process ID of the transaction from the graphic code, wherein the graphic code is generated by a payment system from its acquired transaction information of the transaction, the transaction information including at least ID of a first party and a transaction value of the transaction. The device transmits a user account of a second party and the process ID to the payment system. The payment system acquires the transaction information of the transaction according to the process ID, and reduces the transaction value from a first value included in the user account of the second party and adds the transaction value to a second value included in the user account of the first party according to the transaction information.

In another aspect, a method for processing transactions includes: acquire transaction information of a transaction, the transaction information including at least ID of a first party and a transaction value of the transaction; generate a graphic code of the transaction according to the transaction information, the transaction information including a process ID of the transaction, causing a device to scan the graphic code and to acquire the process ID from the graphic code; receive a user account of a second party and the process ID transmitted from the device, reduce the transaction value from a first value included in the user account of the second party and add the transaction value to the user account of the first party according to the process ID.

A system for processing transactions, comprising: a device and a payment system, the device comprising a scanning module and a transmission module. The scanning module is configured to scan a graphic code of a transaction, and to acquire a process ID of the transaction from the graphic code. The graphic code is generated by a payment system from its acquired transaction information of the transaction, the transaction information including at least ID of a first party and a transaction value of the transaction. The transmission module is configured to transmit a user account of a second party and the process ID to the payment system. The payment system is configured to acquire the transaction information of the transaction according to the process ID, to reduce the transaction value from a first value included in the user account of the second party and to add the transaction value to a second value included in the user account of the first party according to the transaction information.

An apparatus for processing transactions, comprising: an acquisition module configured to acquire transaction information of a transaction, the transaction information including at least ID of a first party and a transaction value of the transaction; a generation module configured to generate a graphic code of the transaction according to the transaction information, the transaction information including a process ID of the transaction, causing a first terminal to scan the graphic code and to acquire the process ID from the graphic code; a reception module configured to receive a user account of a second party and the process ID transmitted from the first terminal, to reduce the transaction value from a first value included in the user account of the second party and to add the transaction value to the user account of the first party according to the process ID.

In this embodiment of the disclosure, a first terminal scans a graphic code of a transaction, acquires a process ID of the transaction from the graphic code, transmits a user account of a second party and the process ID to a payment system; the payment system acquires transaction information of the transaction according to the process ID, reduces the transaction value from a first value included in the user account of the second party and adds the transaction value to a second value included in the user account of the first party according to the transaction information. Thus it saves the second party the trouble of using cash or card to make payment, thereby improving processing convenience and reducing operating cost of the first party.

### BRIEF DESCRIPTION OF THE DRAWINGS

FIG. 1 is a process flow diagram of a method for processing transactions provided by an embodiment of the present disclosure.

FIG. 2 is a process flow diagram of a method for processing transactions provided by an embodiment of the present disclosure.

FIG. 3 is a process flow diagram of a method for processing transactions provided by an embodiment of the present disclosure.

FIG. 4 is a process flow diagram of a method for processing transactions provided by an embodiment of the present disclosure.

FIG. 5 is a structural block diagram of a system for processing transactions provided by an embodiment of the present disclosure.

FIG. 6 is a process flow diagram of a method for processing transactions provided by an embodiment of the present disclosure.

FIG. 7 is a schematic block diagram of a system for processing transactions provided by an embodiment of the present disclosure.

FIG. 8 is a schematic block diagram of an apparatus for processing transactions provided by an embodiment of the present disclosure.

### DETAILED DESCRIPTION OF THE DRAWINGS

For a better understanding of the aim, technical schemes and advantages of the present disclosure, example embodiments are described in detail in connection with the accompanying drawings as follows.

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

Referring to FIG. 1, this embodiment of the disclosure provides a method for processing transactions, and the method includes the following acts:

Step 101: a first terminal scans a graphic code of a transaction, acquires a process ID of the transaction from the graphic code, wherein the graphic code is generated by a payment system from its acquired transaction information of the transaction, the transaction information including at least ID of a first party and a transaction value of the transaction;

Step 102: the first terminal transmits a user account of a second party and the process ID to the payment system;

Step 103: the payment system acquires the transaction information of the transaction according to the process ID, and reduces the transaction value from a first value included in the user account of the second party and adds the transaction value to a second value included in the user account of the first party according to the transaction information.

In this embodiment of the disclosure, the transaction may be related to a product or service between a first party and a second party. The first party may be a merchant using a device and the second party may be a customer using the first terminal. The graphic code of the transaction may be a two-dimensional code or barcode. The first terminal may be a mobile terminal device installed with a processing system, e.g. the first terminal may be a mobile phone, a tablet computer, a personal digital assistant (PDA), or any device having a processor. The payment system may be a computing device or a computer system including at least one computing device such as a computer server. The payment system may also include a database that stores information related to the first and second parties.

In this embodiment of the disclosure, a first terminal scans a graphic code of a transaction, acquires a process ID of the transaction from the graphic code, transmits a user account of a second party and the process ID to a payment system; the payment system acquires transaction information of the transaction according to the process ID, reduces the transaction value from a first value included in the user account of the second party and adds the transaction value to a second value included in the user account of the first party according to the transaction information. Thus it saves the second party the trouble of using cash or card to make payment, thereby improving processing convenience and reducing operating cost of the first party.

This embodiment of the disclosure provides a method for processing transactions.

In this embodiment of the disclosure, a device corresponding to a first party acquires transaction information of the transaction, transmits the transaction information of the transaction to a payment system, causing the payment system to generate a graphic code of the transaction, and the device corresponding to the first party displays the graphic code of the transaction. A first terminal scans the graphic code of the transaction displayed by the device corresponding to the first party, acquires a process ID of the transaction, and transmits a user account of a second party and the process ID to the payment system; and the payment system processes the transaction according to the user account of the second party and the process ID. Referring to FIG. 2, the method comprises:

Step 201: a first device corresponding to a first party forms a processing order of a transaction, acquires transaction information of the transaction according to the processing order, the transaction information of the transaction including ID of the first party, order number of the transaction and a transaction value of the transaction;

Further, the transaction information may also include descriptive information of the transaction.

For example, the device corresponding to the first party scans the graphic code of the transaction, forms a processing order of the transaction according to the graphic code of the transaction, the processing order including order number, ID of the first party, descriptive information of the transaction and transaction value of the transaction, and acquires the transaction information of the transaction from the processing order.

Wherein, the descriptive information of the transaction may include the name and/or price thereof. The transaction may be related to a merchandise or service. The transaction value of the transaction may be the monetary amount required to pay for the transaction. The first party may be a merchant. The device corresponding to the first party may be a terminal device such as a cashier counter, a computer, a smart phone, or any computing device having a processor.

Wherein, when processing the transaction, the second party may hand the object to a cashier, and the cashier may use the device corresponding to the first party to scan the barcode of the transaction. The second party may be a user, a customer, or anyone that deals with the first party.

Step 202: the device corresponding to the first party transmits the transaction information of the transaction to a payment system. The device corresponding to the first party may use an encryption key to encrypt the transaction information of the transaction, and transmit the encrypted transaction information of the transaction to the payment system.

Step 203: the payment system receives the transaction information of the transaction, acquires a graphic code of the transaction according to the transaction information of the transaction, the graphic code including a process ID of the transaction.

For example, the payment system acquires and receives a timestamp of the transaction information of the transaction, performs hashing calculation for the timestamp and the transaction information of the transaction to obtain a process ID of the transaction, and converts the process ID to a graphic code of the transaction; or numbers the transaction information of the transaction after receiving the transaction information, the number being configured to uniquely identify the transaction information of the transaction, determines the number as a process ID of the transaction, and converts the process ID to a graphic code of the transaction.

The act of “the payment system performs a hashing calculation for the timestamp and the transaction information of the transaction to obtain a process ID of the transaction” may include the following:

the payment system uses a hashing algorithm to perform hashing calculation for the timestamp and the transaction information of the transaction to generate a hash value, and as the timestamp of the reception of the transaction is unique, the generated hash values uniquely correspond to the transaction information of the transaction; and the payment system determines the generated hash value as the process ID of the transaction.

The payment system may use the current graphic code conversion algorithm to convert the process ID of the transaction to a graphic code of the transaction. In addition, the graphic code of the transaction may be a two-dimensional code or barcode.

Further, if the transaction information of the transaction is encrypted, then the payment system may verify the validity of the first party as follows:

use a decryption key to decrypt the transaction information of the transaction; if the decryption is successful, verification of the validity of the first party is passed, and if the decryption is unsuccessful, verification of the validity of the first party is not passed, where the first party and the payment system have agreed on a set of encryption and decryption keys in advance.

For example, if the device corresponding to the first party transmits transaction information 1 of the transaction to the payment system; the payment system receives the transaction information 1 of the transaction, acquires a timestamp T1 of the transaction information 1 of the transaction, performs hashing calculation for the timestamp T1 and the transaction information 1 of the transaction to obtain a hash value hash1, determines the hash value hash1 as a process ID of the transaction information 1 of the transaction, converts the process ID hash1 of the transaction to a graphic code 1 of the transaction, wherein the graphic code 1 includes the process ID hash1 of the transaction.

Step 204: the payment system creates a corresponding relationship between the process ID and the transaction information of the transaction, and transmits the graphic code of the transaction to the device corresponding to the first party;

For example, the payment system takes the process ID and the transaction information of the transaction as a record and stores the record in a corresponding relationship between the process ID and the transaction information, and transmits the graphic code of the transaction to the device corresponding to the first party.

Wherein, the payment system maintains a corresponding relationship between the process ID and the transaction information; e.g. a corresponding relationship between the process ID and the transaction information maintained by the payment system as shown in FIG. 1.

TABLE 1

| Process ID | Transaction Information |
|---|---|
| hash2 | Transaction Information 2 |
| . . . | . . . |

Wherein, as shown in Table 2, after acquiring the graphic code 1 of the transaction, the payment system may take the process ID hash1 and the transaction information 1 of the transaction as a record and store the record in a corresponding relationship between the process ID and the transaction information as shown in FIG. 1, and transmit the graphic code 1 of the transaction to the device corresponding to the first party.

TABLE 2

| Process ID | Transaction Information |
|---|---|
| hash2 | Transaction Information 2 |
| hash1 | Transaction Information 1 |
| . . . | . . . |

Step 205: the device corresponding to the first party receives the graphic code of the transaction, and displays the graphic code of the transaction;

wherein, after the device corresponding to the first party displays the graphic code of the transaction, the second party may use the first terminal to scan the graphic code of the transaction displayed by the device corresponding to the first party.

Step 206: the first terminal scans the graphic code of the transaction displayed by the device corresponding to the first party, and acquires the process ID of the transaction from the scanned graphic code;

Step 207: the first terminal transmits the process ID of the transaction and a user account of the second party to the payment system;

Step 208: the payment system receives the process ID of the transaction, acquires the transaction information of the transaction according to the process ID, and transmits the transaction information of the transaction to the first terminal;

For example, the payment system receives the process ID of the transaction, acquires the transaction information of the transaction from the stored corresponding relationship between the process ID and the transaction information according to the process ID, and transmits the transaction information of the transaction to the first terminal.

For example, the device corresponding to the first party receives a graphic code 1 of the transaction, and displays the graphic code 1 of the transaction; the first terminal scans the graphic code 1 of the transaction displayed by the device corresponding to the first party, acquires a process ID hash1 of the transaction from the scanned graphic code 1, transmits the process ID hash1 of the transaction to the payment system; the payment system receives the process ID hash1 of the transaction, searches for the corresponding relationship between the process ID and the transaction information as shown in FIG. 2 and finds the transaction information 1 of the transaction, and transmits the transaction information 1 of the transaction to the first terminal.

Step 209: the first terminal receives the transaction information of the transaction and displays the transaction information of the transaction, causing the second party to determine whether to process the transaction;

Step 210: the first terminal transmits the process ID of the transaction and the user account of the second party to the payment system, if the second party determines to process the transaction. The second party may input the user account to the first terminal After the second party inputs the user account once, the first terminal may save the user account of the second party. Hence the first terminal may directly acquire the user account of the second party saved thereby.

Step 211: the payment system receives the process ID of the transaction and the user account of the second party and acquires the transaction information of the transaction according to the process ID, the transaction information including ID of the first party and a transaction value.

For example, the payment system receives the process ID of the transaction and the user account of the second party and acquires the transaction information of the transaction from the stored corresponding relationship between the process ID and the transaction information according to the process ID.

Step 212: the payment system reduces the transaction value from a first value included in the user account of the second party, acquires a user account of the first party according to the ID of the first party, and adds the transaction value to a second value included in the user account of the first party.

The payment system acquires a corresponding user account according to the ID of the first party, reduces the transaction value from a first value included in the user account of the second party according to the transaction value of the transaction, and adds the transaction value reduction of the transaction to a second value included in the user account of the first party, and the payment system transmits a success notification message to the device corresponding to the first party, the notification message carrying order number of the transaction.

Here, after the device corresponding to the first party receives the success notification message transmitted from the payment system, the first party becomes aware of the successful processing of the object and allows the second party to take away the object.

In this embodiment of the disclosure, the first terminal may also not let the second party determine whether to process the transaction, i.e. the first terminal acquires the process ID of the transaction from the scanned graphic code, transmits the process ID of the transaction and the user account of the second party to the payment system, and the payment system then performs the process from the aforementioned step 211.

In this embodiment of the disclosure, the first terminal may be a mobile phone, a panel computer, a personal digital assistant, or any terminal device that can access the Internet.

In this embodiment of the disclosure, a first terminal scans a graphic code of a transaction, acquires a process ID of the transaction from the graphic code, transmits a user account of a second party and the process ID to a payment system; the payment system acquires transaction information of the transaction according to the process ID, reduces the transaction value from a first value included in the user account of the second party and adds the transaction value to a second value included in the user account of the first party according to the transaction information. Thus it saves the second party the trouble of using cash or card to make payment, thereby improving processing convenience and reducing operating cost of the first party.

This embodiment of the disclosure provides a method for processing transactions.

In this embodiment of the disclosure, a server of a first party acquires transaction information of a transaction and transmits the transaction information of the transaction to a payment system, causing the payment system to generate a graphic code of the transaction. The server may be a web server. The web server of the first party displays the graphic code of the transaction on a web page included by the web server; a first terminal scans the graphic code of the transaction displayed on the web page included by the web server of the first party, acquires a process ID of the transaction, and transmits the process ID and a user account of a second party to the payment system; the payment system processes the transaction according to the process ID and the user account of the second party.

Referring to FIG. 3, the method includes:

Step 301: a server of a first party acquires transaction information of a transaction, the transaction information of the transaction including ID of the first party, order number of the transaction and a transaction value of the transaction.

For example, the second party may use a personal computer (PC) to access the shopping web page included by the web server of the first party, and a second party generates a processing order of the transaction on the shopping web page. The PC terminal device transmits the processing order of the transaction to the web server of the first party; the web server of the first party acquires the transaction information of the transaction according to the processing order of the transaction.

The transaction information of the transaction may include descriptive information thereof.

Step 302: the server of the first party transmits the transaction information of the transaction to a payment system.

The web server of the first party may use an encryption key to encrypt the transaction information of the transaction and transmit the encrypted transaction information of the transaction to the payment system.

Step 303: the payment system receives the transaction information of the transaction, acquires a graphic code of the transaction according to the transaction information of the transaction, the graphic code including a process ID of the transaction;

For example, the payment system acquires and receives a timestamp of the transaction information of the transaction, performs hashing calculation for the timestamp and the transaction information of the transaction to obtain a process ID of the transaction, and converts the process ID to a graphic code of the transaction; or numbers the transaction information of the transaction after receiving the transaction information, the number being configured to uniquely identify the transaction information of the transaction, determines the number as a process ID of the transaction, and converts the process ID to a graphic code of the transaction.

Wherein, the operation of “the payment system performs a hashing algorithm for the timestamp and the transaction information of the transaction to obtain a process ID of the transaction” may include the following:

the payment system uses a hashing algorithm to perform hashing calculation for the timestamp and the transaction information of the transaction to generate a hash value, and as the timestamp of the reception of the transaction is unique, the generated hash values uniquely correspond to the transaction information of the transaction; and the payment system determines the generated hash value as the process ID of the transaction.

For example, the payment system may use the current graphic code conversion algorithm to convert the process ID of the transaction to a graphic code of the transaction.

Further, if the transaction information of the transaction is encrypted, then the payment system may verify the validity of the first party as follows:

use a decryption key to decrypt the transaction information of the transaction; if the decryption is successful, verification of the validity of the first party is passed, and if the decryption is unsuccessful, verification of the validity of the first party is not passed, wherein the first party and the payment system have agreed on a set of encryption and decryption keys in advance.

Step 304: the payment system creates a corresponding relationship between the process ID and the transaction information of the transaction, and transmits the graphic code of the transaction to the server of the first party;

For example, the payment system takes the process ID and the transaction information of the transaction as a record and stores the record in a corresponding relationship between the process ID and the transaction information, and transmits the graphic code of the transaction to the web server of the first party.

Step 305: the server of the first party receives the graphic code of the transaction, and displays the graphic code of the transaction on a web page included by the web server of the first party;

After receiving the graphic code of the transaction, the web server of the first party may display the graphic code of the transaction on a web page included by the web server of the first party that is accessed on a PC terminal device. Wherein, the web page may be a shopping web page or an ordering page.

After the web server of the first party displays the graphic code of the transaction on a web page included by the web server of the first party, the second party may use the first terminal to scan the graphic code of the transaction displayed on the web page included by the web server of the first party.

Step 306: the first terminal scans the graphic code of the transaction displayed on the web page included by the web server of the first party, and acquires the process ID of the transaction from the scanned graphic code;

Step 307: the first terminal transmits the process ID of the transaction and a user account of the second party to the payment system;

Step 308: the payment system receives the process ID of the transaction, acquires the transaction information of the transaction according to the process ID, and transmits the transaction information of the transaction to the first terminal;

For example, the payment system receives the process ID of the transaction, acquires the transaction information of the transaction from the stored corresponding relationship between the process ID and the transaction information according to the process ID, and transmits the transaction information of the transaction to the first terminal.

Step 309: the first terminal receives the transaction information of the transaction and displays the transaction information of the transaction, causing the second party to determine whether to process the transaction;

Step 310: the first terminal transmits the process ID of the transaction and the user account of the second party to the payment system, if the second party determines to process the transaction. The second party may input the user account to the first terminal After the second party inputs the user account once, the first terminal may save the user account of the second party. Hence the first terminal may directly acquire the user account of the second party saved thereby.

Step 311: the payment system receives the process ID of the transaction and the user account of the second party and acquires the transaction information of the transaction according to the process ID;

For example, the payment system receives the process ID of the transaction and the user account of the second party and acquires the transaction information of the transaction from the stored corresponding relationship between the process ID and the transaction information according to the process ID.

Step 312: the payment system reduces the transaction value from a first value included in the user account of the second party, acquires a user account of the first party according to the ID of the first party, and adds the transaction value to a second value included in the user account of the first party.

The payment system acquires the user account of the second party according to the ID of the second party, reduces the transaction value from the user account of the second party according to the transaction value of the transaction, and adds the transaction value reduction of the transaction to a second value included in the user account of the first party, and the payment system transmits a success notification message to the web server of the first party, the notification message carrying order number of the transaction, causing the first party to deliver the goods to the second party.

In this embodiment of the disclosure, the first terminal may also not let the second party determine whether to process the transaction, i.e. the first terminal acquires the process ID of the transaction from the scanned graphic code, transmits the process ID of the transaction and the user account of the second party to the payment system, and the payment system then performs the process from the aforementioned step 311.

The payment system may also reduce the transaction value from the user account of the second party and temporarily keep the transaction value, transmits a delivery notification message to the web server of the first party, the delivery notification message carrying order number and other information of the transaction, causing the first party to perform delivery processing; when the second party receives the object delivered from the first party, the second party may notify the payment system and the payment system then add the temporarily kept transaction value to the user account of the first party.

Wherein, personal information of users is prone to leak in public places such as Internet café, payments made on PC terminal devices in Internet café can be risky. The method provided by this embodiment of the disclosure is capable of overcoming the problem and improving payment safety with a mobile phone used as a first terminal.

In this embodiment of the disclosure, a first terminal scans a graphic code of a transaction, acquires a process ID of the transaction from the graphic code, transmits a user account of a second party and the process ID to a payment system; the payment system acquires transaction information of the transaction according to the process ID, reduces the transaction value from a first value included in the user account of the second party and adds the transaction value to a second value included in the user account of the first party according to the transaction information. Thus it saves the second party the trouble of using cash or card to make payment, thereby improving processing convenience and reducing operating cost of the first party.

This embodiment of the disclosure provides a method for processing transactions.

In this embodiment of the disclosure, a device corresponding to a first party transmits transaction information of a transaction to a payment system, the payment system generates a graphic code of the transaction, and the first party pastes the graphic code of the transaction on a carrier; a second party needs to process a certain transaction, the second party may use a first terminal to acquire the graphic code of the transaction included in the carrier thereof; the first terminal scans the graphic code of the transaction and acquires a process ID of the transaction, transmits the process ID and a user account of the second party to the payment system; the payment system processes the transaction according to the process ID and the user account of the second party. Referring to FIG. 4, the method includes the following acts:

Step 401: a payment system receives transaction information of a transaction transmitted from a device corresponding to a first party, acquires a graphic code of the transaction according to the transaction information of the transaction, the transaction information including a process ID of the transaction;

For example, the payment system receives transaction information of a transaction transmitted from a device corresponding to a first party, acquires and receives a timestamp of the transaction information of the transaction, performs hashing calculation for the timestamp and the transaction information of the transaction to obtain a process ID of the transaction, and converts the process ID to a graphic code of the transaction; or numbers the transaction information of the transaction after receiving the transaction information, the number being configured to uniquely identify the transaction information of the transaction, determines the number as a process ID of the transaction, and converts the process ID to a graphic code of the transaction.

For example, an operator of the first party may input the transaction information of the transaction to the terminal device and the terminal device transmits the transaction information of the transaction to the payment system.

Step 402: the payment system creates a corresponding relationship between the process ID and the transaction information of the transaction, and notifies the first party of the graphic code of the transaction;

For example, the payment system receives the transaction information 1 of the transaction, acquires a timestamp T1 of the transaction information 1 of the transaction, performs hashing calculation for the timestamp T1 and the transaction information 1 of the transaction to obtain a process ID hash1 of the transaction, determines the hash value hash1 as the process ID of the transaction, converts the process ID hash1 of the transaction to a graphic code 1 of the transaction, wherein the graphic code 1 includes the process ID hash1 of the transaction.

The payment system takes the process ID hash1 and the transaction information 1 of the transaction as a record and stores the record in a corresponding relationship between the process ID and the transaction information as shown in Table 3, and notifies the first party of the graphic code 1 of the transaction.

TABLE 3

| Process ID | Transaction Information |
|---|---|
| hash1 | Transaction Information 1 |
| . . . | . . . |

The carrier of the transaction may be a shelf or advertisement and the first party may paste or place the graphic code of the transaction on the shelf of the object, or place the graphic code of the transaction on the advertisement thereof The first party may paste advertisements of the transaction on walls or bus stop panels, or place the advertisements on web pages.

The second party needs to process the object, i.e. the transaction, the second party may use the first terminal to scan the graphic code on a shelf; or the user may use the first terminal to scan the graphic code of the transaction that is included in advertisement thereof.

Step 403: a first terminal scans the graphic code of the transaction, and acquires the process ID of the transaction from the scanned graphic code;

Step 404: the first terminal transmits the process ID of the transaction and a user account of a second party to the payment system;

For example, the first terminal scans the graphic code 1 on a shelf, acquires a process ID hash1 from the scanned graphic code 1, and transmits the process ID hash1 of the transaction to the payment system.

Step 405: the payment system receives the process ID of the transaction, acquires the transaction information of the transaction according to the process ID, and transmits the transaction information of the transaction to the first terminal;

For example, the payment system receives the process ID of the transaction, acquires the transaction information of the transaction from the stored corresponding relationship between the process ID and the transaction information according to the process ID, and transmits the transaction information of the transaction to the first terminal.

After receiving the process ID of the transaction, the payment system may also search for the corresponding inventory quantity from the stored corresponding relationship between the process ID and the inventory quantity. If the inventory quantity is found to be zero, it indicates processing failure; and if the inventory quantity is found to be not zero, the payment system acquires the transaction information of the transaction according to the process ID.

After acquiring the transaction information of the transaction, the payment system may invoke the merchant's interface based on the transaction to check whether processing is feasible. If the transaction can be processed, the response content found is “processing feasible” and processing continues after confirmation by the second party; and if processing of the transaction is infeasible, then the response content found includes “processing infeasible” and the reasons for infeasibility. The reasons for infeasibility are displayed on the first terminal, and processing is terminated.

Step 406: the first terminal receives the transaction information of the transaction and displays the transaction information of the transaction, causing the second party to determine whether to process the transaction;

For example, the payment system receives the process ID hash1 of the transaction, searches for the corresponding relationship between the process ID and the transaction information as shown in Table 3 according to the process ID hash1 of the transaction and finds the transaction information 1 of the transaction, transmits the transaction information 1 of the transaction to the first terminal; the first terminal displays the transaction information 1 of the transaction, causing the second party to determine whether to process the object.

If the second party determines to process the transaction, then the first terminal transmits the process ID of the transaction and the user account of the second party to the payment system. The second party may input the user account to the first terminal After the second party inputs the user account once, the first terminal may save the user account of the second party. Hence the first terminal may directly acquire the user account of the second party saved thereby.

Step 407: the payment system receives the process ID of the transaction and the user account of the second party, and acquires the transaction information of the transaction according to the process ID;

For example, the payment system receives the process ID of the transaction and the user account of the second party, and acquires the transaction information of the transaction from the stored corresponding relationship between the process ID and the transaction information according to the process ID.

Step 408: the payment system reduces the transaction value from a first value included in the user account of the second party, acquires a user account of the first party according to the ID of the first party, and adds the transaction value to a second value included in the user account of the first party.

If the second party uses the first terminal to scan the graphic code of the transaction in an advertisement of the transaction, then the first terminal also transmits address of the recipient and other information to the payment system.

The payment system acquires a user account corresponding to the first party according to the ID of the first party, reduces the transaction value from the user account of the second party according to the transaction value of the transaction and adds the transaction value reduction to the user account of the first party, and the payment system then notifies the first party of the recipient address, causing the first party to deliver the goods.

In this embodiment of the disclosure, the first terminal may also not let the second party determine whether to process the transaction, i.e. the first terminal acquires the process ID of the transaction from the scanned graphic code, transmits the process ID of the transaction and the user account of the second party to the payment system, and the payment system then performs the process from the aforementioned step 407.

Wherein, if the second party uses the first terminal to scan the graphic code of the object on a shelf, then the payment system adds the transaction value to the user account of the first party, and the payment system transmit a notification message to the first party; thereafter, the second party may take away the object from the shelf.

In this embodiment of the disclosure, a first terminal scans a graphic code of a transaction, acquires a process ID of the transaction from the graphic code, transmits a user account of a second party and the process ID to a payment system; the payment system acquires transaction information of the transaction according to the process ID, reduces the transaction value from a first value included in the user account of the second party and adds the transaction value to a second value included in the user account of the first party according to the transaction information. Thus it saves the second party the trouble of using cash or card to make payment, thereby improving processing convenience and reducing operating cost of the first party.

It must be noted that the foregoing example embodiments may be applied to the system structure shown in FIG. 5. For example, the first party is a merchant, the user account of the first party is a merchant account, the payment system acquires transaction information of a transaction, the process ID generation sub-module of the payment system generates a process ID according to the transaction information of the transaction and generates a graphic code including the process ID, the payment system notifies the first party of the graphic code; the first terminal scans the graphic code from the terminal device, web server, shelf or carrier corresponding to the first party and acquires the process ID, and transmits the process ID and the user account of the second party to the payment system; the payment gateway of the payment system receives the process ID and the user account of the second party, acquires the transaction information of the transaction according to the process ID, and the accounting system of the payment system reduces a transaction value from a first value included in the user account of the second party according to the transaction information of the transaction, and adds the transaction value to a second value included in the merchant account.

Referring to FIG. 6, this embodiment of the disclosure provides a method for processing transactions by a payment system, and the method includes:

Step 501: the payment system acquires transaction information of a transaction, the transaction information including at least ID of a first party and a transaction value of the transaction;

Step 502: the payment system generates a graphic code of the transaction according to the transaction information, the transaction information including a process ID of the transaction, causing a first terminal to scan the graphic code and to acquire the process ID from the graphic code;

Step 503: the payment system receives a user account of a second party and the process ID transmitted from the first terminal, reduces the transaction value from a first value included in the user account of the second party and adds the transaction value to the user account of the first party according to the process ID.

In this embodiment of the disclosure, the method comprises: acquire transaction information of a transaction, the transaction information including at least ID of a first party and a transaction value of the transaction; generate a graphic code of the transaction according to the transaction information, the transaction information including a process ID of the transaction, causing a first terminal to scan the graphic code and to acquire the process ID from the graphic code; receive a user account of a second party and the process ID transmitted from the first terminal, reduce the transaction value from a first value included in the user account of the second party and add the transaction value to the user account of the first party according to the process ID. Thus it saves the second party the trouble of using cash or card to make payment, thereby improving processing convenience and reducing operating cost of the first party.

Referring to FIG. 7, this embodiment of the disclosure provides a system for processing transactions. The system includes: a first terminal 1 and a payment system 2. The first terminal 1 includes a hardware processor 610 and a memory storage 620 accessible to the hardware processor 610. The memory storage 620 may be a non-transitory storage medium non-transitory storage medium. The memory storage 620 is configured to store the following modules implemented by the hardware processor 610: a scanning module 601 and a transmission module 602.

The scanning module 601 is configured to scan a graphic code of a transaction, and to acquire a process ID of the transaction from the graphic code, wherein the graphic code is generated by a payment system 2 from its acquired transaction information of the transaction, the transaction information including at least ID of a first party and a transaction value of the transaction;

The scanning module 602 is configured to transmit a user account of a second party and the process ID to the payment system 2;

The payment system 2 is configured to acquire the transaction information of the transaction according to the process ID, to reduce the transaction value from a first value included in the user account of the second party and to add the transaction value to a second value included in the user account of the first party according to the transaction information.

Here, the scanning module 601 includes at least one of the following sub-modules implemented by the hardware processor 610:

a first scanning sub-module configured to scan a graphic code of a transaction displayed on a web page included by a web server corresponding to a first party, wherein the web server corresponding to the first party acquires transaction information of the transaction and transmits the transaction information of the transaction to a payment system, causing the payment system to generate a graphic code of the transaction according to the transaction information of the transaction and to display the graphic code of the transaction on a web page included by the web server corresponding to the first party; or

a second scanning sub-module configured to scan a graphic code of a transaction displayed on a device corresponding to the first party, wherein the device corresponding to the first party acquires transaction information of the transaction and transmits the transaction information of the transaction to a payment system after forming a processing order of the transaction, causing the payment system to generate a graphic code of the transaction according to the transaction information of the transaction and to display the graphic code of the transaction on a device corresponding to the first party; or

a third scanning sub-module configured to scan a graphic code of a transaction included in a carrier of the transaction, wherein the graphic code of the transaction is generated by a payment system according to the transaction information of the transaction, after a device corresponding to the first party receives the transaction information of the transaction inputted by an operator of the first party and transmits the transaction information to the payment system.

The transmission module 602 includes a first transmission sub-module and a second transmission sub-module;

the first transmission sub-module is configured to transmit the process ID to the payment system;

the payment system 2 is configured to acquire the transaction information of the transaction from the stored corresponding relationship between the process ID and the transaction information according to the process ID, to transmit the transaction information of the transaction to the first terminal 1, causing the second party to determine whether to process the transaction according to the transaction information of the transaction;

the second transmission sub-module is configured to transmit the user account of the second party and the process ID to the payment system 2 if the second party determines to process the transaction;

the payment system 2 is also configured to acquire the transaction information of the transaction from the stored corresponding relationship between the process ID and the transaction information according to the process ID, to reduce the transaction value from a first value included in the user account of the second party and to add the transaction value to a second value included in the user account of the first party according to the transaction information.

In this embodiment of the disclosure, a first terminal scans a graphic code of a transaction, acquires a process ID of the transaction from the graphic code, transmits a user account of a second party and the process ID to a payment system; the payment system acquires transaction information of the transaction according to the process ID, reduces the transaction value from a first value included in the user account of the second party and adds the transaction value to a second value included in the user account of the first party according to the transaction information. Thus it saves the second party the trouble of using cash or card to make payment, thereby improving processing convenience and reducing operating cost of the first party.

FIG. 8 illustrates an apparatus 700 for processing transactions, and the apparatus 700 includes a hardware processor 710 and a non-transitory storage medium 720 accessible to the hardware processor 710. The non-transitory storage medium 720 is configured to store the following modules implemented by the hardware processor 710: an acquisition module 701, a generation module 702, and a reception module 703.

The acquisition module 701 is configured to acquire transaction information of a transaction, the transaction information including at least ID of a first party and a transaction value of the transaction.

The generation module 702 is configured to generate a graphic code of the transaction according to the transaction information, the transaction information including a process ID of the transaction, causing a first terminal to scan the graphic code and to acquire the process ID from the graphic code.

The reception module 703 is configured to receive a user account of a second party and the process ID transmitted from the first terminal, to reduce the transaction value from a first value included in the user account of the second party and to add the transaction value to the user account of the first party according to the process ID.

The acquisition module 701 includes:

a first reception sub-module configured to receive transaction information of the transaction transmitted from a web server of a first party, the transaction information being acquired by the web server of the first party according to a processing order of the transaction submitted by the first party; or

a second reception sub-module configured to receive transaction information of the transaction transmitted from a device corresponding to the first party, the transaction information being acquired by the device corresponding to the first party after the device corresponding to the first party forms a processing order of the transaction according to the processing order of the transaction; or

a third reception sub-module configured to receive transaction information of the transaction transmitted from a device corresponding to the first party, where the device corresponding to the first party receives the transaction information of the transaction inputted by an operator of the first party.

The generation module 702 includes:

a hashing sub-module configured to acquire and receive a timestamp of the transaction information of the transaction, to perform hashing calculation for the timestamp and the transaction information of the transaction to obtain a process ID of the transaction, and to convert the process ID to a graphic code of the transaction; or

a numbering sub-module configured to number the transaction information of the transaction after receiving the transaction information, the number being configured to uniquely identify the transaction information of the transaction, to set the number as a process ID of the transaction, and to convert the process ID to a graphic code of the transaction.

The reception module 703 includes:

an acquisition sub-module configured to acquire the transaction information of the transaction from the stored corresponding relationship between the process ID and the transaction information according to the process ID of the transaction, the transaction information including at least ID of the first party and a transaction value of the transaction;

a reduction sub-module configured to reduce the transaction value from a first value included in the user account of the second party, to acquire the user account of the first party according to the ID of the first party, and to add the transaction value to a second value included in the user account of the first party.

In this embodiment of the disclosure, the method includes: acquire transaction information of a transaction, the transaction information including at least ID of a first party and a transaction value of the transaction; generate a graphic code of the transaction according to the transaction information, the transaction information including a process ID of the transaction, causing a first terminal to scan the graphic code and to acquire the process ID from the graphic code; receive a user account of a second party and the process ID transmitted from the first terminal, reduce the transaction value from a first value included in the user account of the second party and add the transaction value to the user account of the first party according to the process ID. Thus it saves the second party the trouble of using cash or card to make payment, thereby improving processing convenience and reducing operating cost of the first party.

It should be understood by those with ordinary skill in the art that all or some of the steps of the foregoing embodiments may be completed by hardware such as a computing device having a non-transitory storage medium accessible to a hardware processor. The embodiments may also be completed by hardware instructed by program, the program being stored in a non-transitory computer-readable storage medium, and the non-transitory computer readable storage medium may be a read-only memory, a magnetic disk or a compact disk.

Disclosed above are only example embodiments of the present disclosure and these example embodiments are not intended to be limiting the scope of the present disclosure, hence any variations, modifications or replacements made without departing from the spirit of the present disclosure shall fall within the scope of the present disclosure.

What is claimed is:

1. A method for processing transactions, comprising:
scanning, by a first terminal having a processor, a graphic code of a transaction;
acquiring, by the first terminal, a process identity (ID) of the transaction from the graphic code, wherein the graphic code is generated by a payment system from its acquired transaction information of the transaction, the transaction information comprising ID of a first party and a transaction value of the transaction;
transmitting, by the first terminal, a user account of a second party and the process ID to the payment system; and
acquiring, by the payment system, the transaction information of the transaction according to the process ID, reducing the transaction value from a first value in the user account of the second party, and adding the transaction value to a second value in the user account of the first party according to the transaction information.

2. The method as defined in claim 1, wherein scanning the graphic code of the transaction comprises:
scanning, by the first terminal, a graphic code of the transaction displayed on a web page provided by a web server corresponding to the first party, wherein the web server corresponding to the first party acquires transaction information of the transaction and transmits the transaction information of the transaction to the payment system, causing the payment system to generate a graphic code of the transaction according to the transaction information of the transaction and to display the graphic code of the transaction on the web page.

3. The method as defined in claim 1, wherein scanning the graphic code of the transaction comprises:
scanning, by the first terminal, a graphic code of a transaction displayed on a device corresponding to the first party, wherein the device corresponding to the first party acquires transaction information of the transaction and transmits the transaction information of the transaction to a payment system after forming a processing order of the transaction, causing the payment system to generate a graphic code of the transaction according to the transaction information of the transaction and to display the graphic code of the transaction on a device corresponding to the first party.

4. The method as defined in claim 1, wherein scanning the graphic code of the transaction comprises:
scanning, by the first terminal, a graphic code of a transaction included in a carrier of the transaction, wherein the graphic code of the transaction is generated by a payment system according to the transaction information of the transaction, after a device corresponding to the first party receives the transaction information of the transaction inputted by an operator of the first party and transmits the transaction information to the payment system.

5. The method as defined in claim 1, wherein acquiring the transaction information of the transaction according to the process ID, reducing the transaction value from the first value in the user account of the second party, and adding the transaction value to the second value in the user account of the first party according to the transaction information comprise:
acquiring, by the payment system, the transaction information of the transaction from the stored corresponding relationship between the process ID and the transaction information according to the process ID, transmitting the transaction information of the transaction to the first terminal, causing the second party to determine whether to process the transaction according to the transaction information of the transaction;
if the second party determines to process the transaction, transmitting, by the device, the user account of the second party and the process ID to the payment system; and
acquiring, by the payment system, the transaction information of the transaction from the stored corresponding relationship between the process ID and the transaction information according to the process ID, reducing the transaction value from a first value included in the user account of the second party and adding the transaction value to a second value included in the user account of the first party according to the transaction information.

6. A method for processing transactions implemented by a payment system having a processor, comprising:
acquiring, by the payment system, transaction information of a transaction, the transaction information including at least ID of a first party and a transaction value of the transaction;
generating, by the payment system, a graphic code of the transaction according to the transaction information, the transaction information including a process ID of the transaction, causing a terminal to scan the graphic code and to acquire the process ID from the graphic code; and
receiving, by the payment system, a user account of a second party and the process ID transmitted from the terminal, reduce the transaction value from a first value included in the user account of the second party and add the transaction value to the user account of the first party according to the process ID.

7. The method as defined in claim 6, wherein acquiring transaction information of a transaction comprises at least one of the following:
receiving transaction information of the transaction transmitted from a web server of the first party, the transaction information being acquired by the web server of the first party according to a processing order of the transaction submitted by the first party;
receiving transaction information of the transaction transmitted from a device corresponding to the first party, the transaction information being acquired by the device corresponding to the first party after the device corresponding to the first party forms a processing order of the transaction according to the processing order of the transaction; and
receiving transaction information of the transaction transmitted from a device corresponding to the first party, wherein the device corresponding to the first party receives the transaction information of the transaction inputted by an operator of the first party.

8. The method as defined in claim 6, wherein generating a graphic code of the transaction according to the transaction information comprises at least one of the following:
obtaining a timestamp of the transaction information of the transaction, performing hashing calculation for the timestamp and the transaction information of the transaction to obtain the process ID of the transaction, and converting the process ID to a graphic code of the transaction; and
after receiving the transaction information, assigning a number that uniquely identifies the transaction information of the transaction, determining the number as the process ID of the transaction, and converting the process ID to a graphic code of the transaction.

9. The method as defined in claim 6, wherein reducing the transaction value from a first value included in the user account of the second party and adding the transaction value to the user account of the first party according to the process ID comprises:
acquiring the transaction information of the transaction from the stored corresponding relationship between the process ID and the transaction information according to the process ID of the transaction, the transaction information comprising at least ID of the first party and a transaction value of the transaction; and
reducing the transaction value from a first value included in the user account of the second party, acquiring the user account of the first party according to the ID of the first party, and adding the transaction value to a second value included in the user account of the first party.

10. A system for processing transactions, comprising: a device and a payment system, the device comprising a processor and a non-transitory storage medium configured to store a scanning module and a transmission module implemented by the processor; wherein:
the scanning module is configured to scan a graphic code of a transaction, and to acquire a process ID of the transaction from the graphic code, wherein the graphic code is generated by a payment system from its acquired transaction information of the transaction, the transaction information comprising at least ID of a first party and a transaction value of the transaction;
the transmission module is configured to transmit a user account of a second party and the process ID to the payment system; and
the payment system is configured to acquire the transaction information of the transaction according to the process ID, to reduce the transaction value from a first value included in the user account of the second party, and to add the transaction value to a second value included in the user account of the first party according to the transaction information.

11. The system as defined in claim 10, wherein:
the scanning module is configured to scan a graphic code of a transaction displayed on a web page included by a web server corresponding to a first party, wherein the web server corresponding to the first party acquires transaction information of the transaction and transmits the transaction information of the transaction to a payment system, causing the payment system to generate a graphic code of the transaction according to the transaction information of the transaction and to display the graphic code of the transaction on a web page included by the web server corresponding to the first party.

12. The system as defined in claim 10, wherein:
the scanning module is configured to scan a graphic code of a transaction displayed on a device corresponding to the first party, wherein the device corresponding to the first party acquires transaction information of the transaction and transmits the transaction information of the transaction to a payment system after forming a processing order of the transaction, causing the payment system to generate a graphic code of the transaction according to the transaction information of the transaction and to display the graphic code of the transaction on a device corresponding to the first party.

13. The system as defined in claim 10, wherein:
the scanning module is configured to scan a graphic code of a transaction included in a carrier of the transaction, wherein the graphic code of the transaction is generated by a payment system according to the transaction information of the transaction, after a device corresponding to the first party receives the transaction information of the transaction inputted by an operator of the first party and transmits the transaction information to the payment system.

14. The system as defined in claim 10, wherein the transmission module comprises: a first transmission sub-module and a second transmission sub-module; wherein:
the first transmission sub-module is configured to transmit the process ID to the payment system;
the payment system is configured to acquire the transaction information of the transaction from the stored corresponding relationship between the process ID and the transaction information according to the process ID, to transmit the transaction information of the transaction to the device, causing the second party to determine whether to process the transaction according to the transaction information of the transaction;
the second transmission sub-module is configured to transmit the user account of the second party and the process ID to the payment system if the second party determines to process the transaction; and
the payment system is also configured to acquire the transaction information of the transaction from the stored corresponding relationship between the process ID and the transaction information according to the process ID, to reduce the transaction value from a first value included in the user account of the second party and to add the transaction value to a second value included in the user account of the first party according to the transaction information.

15. An apparatus for processing transactions, comprising a processor and a non-transitory storage medium configured to store the following modules implemented by the processor:
an acquisition module configured to acquire transaction information of a transaction, the transaction information including at least ID of a first party and a transaction value of the transaction;
a generation module configured to generate a graphic code of the transaction according to the transaction information, the transaction information including a process ID of the transaction, causing a device to scan the graphic code and to acquire the process ID from the graphic code; and
a reception module configured to receive a user account of a second party and the process ID transmitted from the device, to reduce the transaction value from a first value included in the user account of the second party and to add the transaction value to the user account of the first party according to the process ID.

16. The apparatus as defined in claim 15, wherein the acquisition module comprises at least one of the following sub-modules implemented by the processor:
a first reception sub-module configured to receive transaction information of the transaction transmitted from a web server of a first party, the transaction information being acquired by the web server of the first party according to a processing order of the transaction submitted by the first party;
a second reception sub-module configured to receive transaction information of the transaction transmitted from a device corresponding to the first party, the transaction information being acquired by the device corresponding to the first party after the device corresponding to the first party forms a processing order of the transaction according to the processing order of the transaction; and
a third reception sub-module configured to receive transaction information of the transaction transmitted from a device corresponding to the first party, wherein the device corresponding to the first party receives the transaction information of the transaction inputted by an operator of the first party.

17. The apparatus as defined in claim 15, wherein the generation module comprises at least one of the following sub-modules implemented by the processor:
a hashing sub-module configured to acquire and receive a timestamp of the transaction information of the transaction, to perform hashing calculation for the timestamp and the transaction information of the transaction to obtain a process ID of the transaction, and to convert the process ID to a graphic code of the transaction; and
a numbering sub-module configured to assign a number based on the transaction information of the transaction after receiving the transaction information, the number being configured to uniquely identify the transaction information of the transaction, to set the number as the process ID of the transaction, and to convert the process ID to a graphic code of the transaction.

18. The apparatus as defined in claim 15, wherein the reception module comprises the following sub-modules implemented by the processor:
an acquisition sub-module configured to acquire the transaction information of the transaction from the stored corresponding relationship between the process ID and the transaction information according to the process ID of the transaction, the transaction information including at least ID of the first party and a transaction value of the transaction; and
a reduction sub-module configured to reduce the transaction value from a first value included in the user account of the second party, to acquire the user account of the first party according to the ID of the first party, and to add the transaction value to a second value included in the user account of the first party.
